(19) United States
(12) Patent Application Publication
(10) Pub. No.: US 2014/0349002 A1
(43) Pub. Date: Nov. 27, 2014

(54) Ingestible Compositions Containing Criollo Avocado Component

(71) Applicant: The Iams Company, Cincinnati, OH (US)

(72) Inventors: Susan Ruth Beyer, Lebanon, OH (US); Robbert H. Ter Haar, Lebanon, OH (US)

(73) Assignee: The Iams Company, Cincinnati, OH (US)

(21) Appl. No.: 14/283,314

(22) Filed: May 21, 2014

Related U.S. Application Data
(60) Provisional application No. 61/826,517, filed on May 23, 2013.

(51) Int. Cl. A23K 1/16; A23K 1/175

(52) U.S. Cl. CPC A23K 1/1643; A23K 1/1603; A23K 1/175
USPC 426/648

(57) ABSTRACT

The undomesticated, i.e., criollo-type of avocado found growing in the tropics, particularly in the Dominican Republic, is used to prepare nutritional compositions for oral ingestion by humans and lower animals, especially pets such as dogs and cats.

### FIELD OF THE INVENTION

The undomesticated, i.e., criollo-type of avocado found growing in the tropics, particularly in the Dominican Republic, is used to prepare nutritional compositions for oral ingestion by humans and lower animals, especially pets such as dogs and cats.

### BACKGROUND OF THE INVENTION

Research spanning more than sixty years has shown that caloric restriction comprises a nutritional intervention that consistently extends longevity in animals. Pet food compositions have been reported that contain certain materials such as mannoheptulose that block or inhibit certain aspects of carbohydrate metabolism and may therefore mimic the effects of caloric restriction. The present invention is based on the discovery of the unexpectedly rich source of mannoheptulose and other desirable materials such as the C₇ sugar alcohol, perseitol, as well as various C₆ sugars, in the criollo avocado.

Mannoheptulose may be produced synthetically or may be extracted from natural plant sources, especially avocados. Manufacturers of food compositions, especially pet foods for dogs and cats, are well-aware of the preference of their customers for naturally-derived ingredients in such compositions. Accordingly, the naturally-derived mannoheptulose is preferred for food use.

Securing a source of naturally-derived mannoheptulose in an economically viable manner and on a large scale is key to the commercialization of food products containing this desirable material. While various laboratory-scale methods for extracting mannoheptulose from avocados have been reported, it has now been determined that such methods can result in the formation of fluid concentrates that require further processing (i.e. concentration and drying). Moreover, such methods require processing equipment that is capital-intensive.

While pet foods comprising isolates made from avocados are known, the aforementioned problems, as well as the expense of preparing such isolates, make them economically unattractive on a large scale. Moreover, while some commercial pet food purportedly contains some proportion of avocado, per se, the amount appears to be so slight that essentially no measurable amount of mannoheptulose appears to be present. The fact that the levels are not measurable is likely due to the starting level in the fruit, the instability of mannoheptulose in the finished ingredient form and the processing conditions used to make the final product.

From an economic standpoint, it would be most advantageous to be able to use the whole avocado fruit, rather than using isolated or concentrates. However, it has now been determined that such use can be problematic, for several reasons.

First, the flesh of many species of avocado contains only small amounts (typically, less than about 0.02%, by weight) of mannoheptulose. Accordingly, providing an effective amount of mannoheptulose in the food product would require adding such a high level of the avocado flesh that desirable organoleptic qualities of the product could undesirably change. For example, a dog food product originally designed and formulated to mimic a meaty product could take on a more vegetable-like aspect, and thus be less acceptable to the pet.

Moreover, many varieties of avocado have been bred, not for their mannoheptulose content, but rather for taste qualities similar to Hass avocados that have a high oil content. In any event, such high levels of oily avocado material could negatively affect formulation flexibility. Such problems are minimized herein by using criollo avocado.

In addition, many varieties of avocado lose a considerable amount of their mannoheptulose during fruit ripening, storage and processing. However, extracting mannoheptulose from freshly harvested, unripened fruit may be problematic, due to the comparative hardness of the fruit. In any event, additional mannoheptulose can also be lost during post-harvest storage, which necessitates further expense due to the need for refrigerated or frozen storage facilities to help preserve mannoheptulose content.

It has now been discovered that food products, especially food products for companion animals such as dogs, cats, horses, and the like, as well as for humans, can be provided with quantities of mannoheptulose and perseitol sufficient to block or inhibit certain aspects of carbohydrate metabolism and thereby mimic the effects of caloric restriction, by using the criollo avocado as a source of these valuable materials.

Furthermore, it has now been discovered that criollo avocados grown in the Dominican Republic have an unexpectedly high concentration of mannoheptulose and perseitol, as well as a relatively low oil content. Moreover, the unexpectedly increased concentration and the stability of mannoheptulose in the criollo avocados used in the manner disclosed herein means that an effective amount of the mannoheptulose can be provided to the food without risking overall organoleptic acceptability and without excess oil.

### SUMMARY OF THE INVENTION

In its broadest aspect, the present invention relates to the use of criollo avocado in the manufacture of orally ingestible compositions.

In one aspect, the invention provides a method for supplying a member selected from the group consisting of mannoheptulose, perseitol and mixtures thereof to an edible food composition component, said food composition component comprising a non-avocado derived member selected from the group consisting of protein, fat, carbohydrate and mixtures thereof, by combining a criollo avocado-derived component containing said mannoheptulose, perseitol or mixtures thereof with said food composition component. In one mode, said criollo is a member selected from the group consisting of criollo West Indian avocado, criollo West Indian/Guatemalan hybrid avocado and mixtures thereof, especially avocado grown in the Dominican Republic. Optimally, said criollo avocado is an early harvest criollo avocado. The method herein provides food compositions wherein said criollo avocado-derived component comprises the criollo avocado flesh plus a member selected from avocado pit, avocado peel, or both pit and peel. Alternatively, the criollo avocado-derived component can be an aqueous extract comprising said mannoheptulose and optionally perseitol.

The method includes aspects wherein said food composition component is animal protein, or is a plant carbohydrate such as those derived from a farinaceous source, or is a non-avocado fat comprising omega-3 fatty acid moieties, or mixtures thereof. Thus, the method provides an animal food composition comprising a nutritionally balanced mixture of said protein, carbohydrate, fat, optional vitamins and minerals, and an amount of criollo avocado-derived component to provide an effective amount of mannoheptulose sufficient to provide a desired physiological response, especially to mimic the effects of caloric restriction in said animal.

### DETAILED DESCRIPTION

This application claims the benefit of U.S. Provisional Application Ser. No. 61/826,517, the entirety of which is incorporated by reference herein.

As used herein, “mannoheptulose” means the well-known 7-carbon atom monosaccharide C₇H₁₄O₇, also commonly referred to as “D-mannoheptulose.” “Perseitol” has the empirical formula C₇H₁₆O₇ and is the polyol, i.e., reduced, form of mannoheptulose. Such compounds may be referred to as “C₇” materials.

Various other desirable C₆ and C₇ antimetabolite materials available from the avocado include, but are not limited to: 2-deoxy-D-glucose; 5-thio-D-glucose; 3-O-methylglucose; 1,5-anhydro-D-glucitoc; 2,5-anhydro-D-glucitol; 2,5-anydro-D-mannitol; and mixtures thereof with each other and with perseitol and mannoheptulose. As disclosed hereinafter, it has now been discovered that the criollo avocado is an unexpectedly rich source of both mannoheptulose and perseitol. Accordingly, processes that embody the use of criollo avocado to provide a mixture of mannoheptulose and perseitol comprise especially useful, but non-limiting, embodiments of the present invention.

All percentages, parts and ratios as used herein are by weight of the total composition, unless otherwise specified. All such weights as they pertain to listed ingredients are based on the active level and, therefore do not include solvents or by-products that may be included in commercially available materials, unless otherwise specified. All numerical units are within the normal degree of accuracy afforded by the art, unless otherwise specified.

### West Indian and Hybrid Avocados

The present invention employs West Indian or hybrids of West Indian/Guatemalan avocados. By “West Indian” herein is meant the well-characterized botanical species Persea americana var. americana. By “Guatemalan” is meant Persea americana var. guatemalensis. By “West Indian Hybrid” herein is meant hybrids obtained by combining said West Indian and Guatemalan species.

Non-limiting examples of West Indian and West Indian/Guatemalan hybrid avocados for use herein include the following:

West Indian—Butler; Fuchs; General Bureau; Maoz; Pollock; Ruchle; Russell; Simmonds; Trapp; Waldin; Alzamora; Avila; Faria; Garcia; Hernandez; St. Just; Amador; Galo; Gimenez; Lewis; Torres; Trujillo; Yamagata.

West Indian/Guatemalan Hybrids—Bonita; Booth 1; Booth 7; Booth 8; Chequette; Collinson; Fuchs-20; Grande; Hall; Herman; Hickson; Kahaluu; Simpson; Winslowson; Gripina 2; Gripina 5; Gripina 12; Semil 23; Semil 31; Semil 34; Semil 42; Semil 43, Semil 44.

Such avocados are typically domesticated using standard horticultural techniques such as pruning, fertilizing, irrigating, treating with pesticides and the like, and contain the desired mannoheptulose and/or perseitol compounds at reasonably high levels.

### “Criollo” Avocado

Surprisingly, it has now been discovered that the so-called “criollo” avocado is an unexpectedly rich source of mannoheptulose and perseitol and is highly preferred for use in the present process and compositions. The criollo avocado used herein comprises the undomesticated tropical West Indian and West Indian/Guatemalan hybrid species, such as those noted above, found growing generally in a band between 25° north and 25° south latitudes. In particular, the criollo now discovered to have the highest mannoheptulose and perseitol levels grows in the Dominican Republic, especially in mountainous regions. Criollo avocados are available in sufficient quantities to be usable as a commercial source of these C₇ materials in the present manner. Suppliers include Fresh Directions Dominicana in the Dominican Republic and Brooks Tropicals in Florida, USA.

The criollo avocado has been largely ignored, other than for local usage mainly in its region of origin and its use as a source of mannoheptulose and/or perseitol in the manner of this invention seems to have gone unreported. Since the criollo is undomesticated, it grows in an uncultivated state without fertilization, artificial irrigation and pesticides. Unlike the more familiar avocado species, the criollo trees are typically not pruned and their height makes them easy to distinguish from their shorter, cultivated counterparts. Their fruit tends to be relatively large, green and smooth-skinned.

Except for the present invention, it is unlikely that the criollo avocado would ever have been considered of major commercial interest outside its locale of origin, because edible avocados are generally bred for their high fat content, i.e., as avocado oil, not for their mannoheptulose and perseitol content. For example, while the mannoheptulose content of the flesh of the Hass avocado averages only about 1.4% (wt.) in the unripe fruit and decreases considerably in the ripe fruit, the flesh of the criollo averages about 2.1% (wt.) mannoheptulose in the unripe fruit, which does not decrease in the criollo fruit processed in the optimized manner described herein. Moreover, the pit and peel contain additional amounts of the C₇ materials. The result is that the use of the whole criollo fruit provides an exceptionally rich source of mannoheptulose and perseitol. The high level of mannoheptulose in the criollo and its unexpected retention, or even increase, after processing in such manner make the criollo uniquely suited for commercial use as a source of these C₇ materials. For further perspective, the Hass fruit, treated in the present manner, has about 0.57% mannoheptulose versus the much higher mannoheptulose levels from criollo. In sharp contrast, typical mannoheptulose levels in conventional, commercial Hass fruit flesh are not measurable, or are less than 0.1%.

Moreover, the content of the other important avocado-derived sugars has now also been found to be considerably greater in the flesh of the criollo avocado than in cultivated avocados, such as the Hass. For example, the Hass averages 473 ppm glucose and 5,981 ppm perseitol in the unripe fruit and 1,421 ppm glucose and 621 perseitol in the ripe fruit. In sharp contrast, the West Indian type criollo avocado averages 931 ppm glucose in the unripe fruit and 1,985 ppm in the ripe fruit and 14,207 ppm perseitol in the unripe fruit and 11,963 ppm in the ripe fruit.

It should be noted that the levels of C₇ compounds can vary with avocado species, depending on the time of harvest. In general, the early-harvest fruit has the highest levels of mannoheptulose and is therefore optimal for use herein. It is well-know, to growers that the various species have differing harvest times. Harvest time is established by such factors as fruit size or weight. June is considered “early” harvest for criollo, whereas late September is early harvest for Semil 34. In any event, the key is to harvest the fruit when it reaches its peak level of mannoheptulose or mannoheptulose plus perseitol. If desired, the chromatographic analysis disclosed hereinafter could be used to establish peak levels quantitatively and provide a definition of “early” harvest times. However, reliance on the skill of the grower to judge when to harvest “early” is usually sufficient. In contract to early harvest, “late” harvest is when the oil content of the fruit is typically greatest. “Late” harvest is more generally the norm in the industry, since the oily late harvest avocados have the organoleptic quantities typically desired in human food. If desired, the chromatographic method disclosed hereinafter can be used to identify early harvest criollo, by virtue of its high mannoheptulose content.

Optimized Avocado Treatment with Ethylene Gas

As noted above, avocados harvested early in the season tend to have higher mannoheptulose levels than those harvested late in the season. Accordingly, the processing conditions are described herein are for criollo avocados harvested early in the season. The fruit is monitored every 4 hours throughout the ethylene gas treatment stage of the process herein to ensure that it does not reach penetrometer readings below the 2 LBF limit, since that results in unacceptable losses of mannoheptulose. Accordingly, the process is monitored to ensure that the fruit preferably does reach penetrometer readings of <5 LBF. The proper balance between optimal mannoheptulose/perseitol levels corresponds quite well with the target penetrometer readings of >2 and <5 LBF, as described in more detail, below.

A novel and quite unexpected advantage of the criollo over avocados such as the Hass is the criollo's shortened treatment time. In general terms, exposing criollo avocados to an atmosphere of ethylene gas for about one day is sufficient treatment, whereas the Hass requires about three days. This, of course, represents another considerable processing advantage for the criollo.

As a general proposition, all avocado fruit that is harvested later in the season may reach the optimal hardness even faster than 24 hours. While each batch of fruit may be somewhat different, the formulator can always use these tests to indicate readiness of the fruit to be used, as is, or to be converted into pulp.

In a typical, but non-limiting, process the criollo avocado is exposed to ethylene gas in a “ripening room” for about 24 hours. Ripening room conditions: temp. 18-22° C., ethylene gas at 100 ppm; humidity 95-99%; room is vented and air is circulated.

Various, optional aspects of the processing are also disclosed hereinafter, not by way of limitation, but solely for the convenience of the formulator. A chromatographic method for quantitatively analyzing the content of mannoheptulose and other sugars and a method for measuring fat content are also disclosed hereinafter.

In one aspect the harvested avocados used in the process are all of the same general size (±15-20%). This helps ensure that all avocados in any batch being contacted by the ethylene gas reach the target penetrometer reading at the same time. In another aspect, the avocados may optionally, but preferably, be sanitized before processing, e.g., by exposure for one minute to 200 ppm chlorine. In order to optimize levels of mannoheptulose and perseitol, the fruit is preferably cooled to 45° F. within 48 hours of harvesting. After processing, the avocados may be ground, macerated and used as a criollo-derived source of the C₇ compounds.

The avocado material can then optionally be mixed with preservatives such as food grade ascorbic acid, citric acid, or mixtures thereof and optionally bagged (e.g., vacuum packaged) and preferably frozen for later use. Ascorbic acid (or salts thereof) is typically used at 0.1-0.5 wt %; citric acid (or salts thereof) is typically used at 0.1-0.5 wt. %. An especially useful preservative for frozen criollo material comprises a mixture of 0.3% ascorbic acid and 0.16% citric acid, by wt. of the comminuted material. Ideally, the frozen pulp composition has a pH of 4.5, or less, when thawed and the pH is measured on the macerated pulp without adding water. The acidic pH enhances stability. Various processing safeguards, such as metal detectors, can be used to ensure product safety, hygiene and the like.

The mannoheptulose stability of criollo pulp stored frozen (−20° C.) is 11.0% loss of mannoheptulose after 90 days. Use of the frozen criollo avocado to prepare food compositions for human or animal use may comprise breaking/crushing frozen blocks of the material, which is used as is, or by adding water to provide a flowable paste; and optionally standardizing the paste to a target mannoheptulose and/or perseitol content by further dilutions with water.

In another aspect, an aqueous extract containing the C₇ materials can be separated from the fruit solids and used as the criollo component to prepare the various food compositions disclosed hereinafter.

### Penetrometer Test Procedure

The penetrometer measures the force required to push a plunger tip having a specified size into the avocado flesh. These force readings assist in determining the appropriate avocado harvesting time and to monitor fruit softening during treatment with ethylene gas.

When the fruit to be tested is removed from the ethylene treatment its temperature is in the 18-22° C. range and the penetrometer test is run while the fruit is at that temperature range. Penetrometer readings are taken at two locations on the fruit using a Wagner Penetrometer Model No. FT40 with Gage FDK40 with a 13 mm tip. This has a capacity of 40 LBF (18.18 KF) and accuracy of ±1 graduation. A 13 mm tip is used. The meter is used with the Wagner FTK test stand.

1. A thin disc of skin is removed with the Wagner FT/PRL fruit peeler on the fruit midway between the stem ad the bottom of the fruit. Then the fruit is rotated approximately 45 degrees and a second disc of skin is removed with the peeler. These are the test sites for the penetrometer.

2. Place the avocado in the Wagner FTK Test Stand for controlled testing.

3. Force the tip vertically into the flesh at a constant, slow speed (take 3 seconds) and the tip should penetrate to the break in the scribed line on the tip or the break in the tip.

4. Record the reading in LBF (pounds force) to the nearest graduation.

5. The two readings are averaged.

The fruit must all be approximately the same size and weight for penetrometer testing. In a typical mode, three avocados at a minimum are tested from a batch undergoing contact with the ethylene at each stage of monitoring. The monitoring is conducted every four hours. Monitoring is discontinued when the optimized target >2 LBF to <5 LBF range is reached. Penetrometer testing of fruit to be harvested can be done in the field. In general, the freshly harvested fruit will be very firm and have a penetrometer reading greater than 5 and can reach 20. Alternatively, such hard criollo avocados can be used as a C₇ source, but can be difficult to process, especially if the pit is to be removed.

### Usage and Formulations

Criollo avocado material provides components selected from 2-deoxy-D-glucose; 5-thio-D-glucose; 3-O-methylglucose; 1,5-anhydro-D-glucitol; 2,5-anhydro-D-glucitol; 2,5-anhydro-D-mannitol; mannoheptulose; perseitol; and mixtures and combinations thereof. Usage will depend upon the size and condition of the human or lower animal to which the compounds or mixtures are to be administered. Usage in the range of about 0.0001 or about 0.001 grams/kg to about 1 g/kg can be beneficial in some embodiments, especially for mannoheptulose. As used herein, when amounts in mg/kg is used, the “mg” refers to the level of the component, such as mannoheptulose, and “kg” refers to kilograms of body weight of the mammal, including humans as well as a pet, such as a dog or cat. Usage at the lower range may also be appropriate when using 2-deoxy-D-glucose in large animals. Higher amounts, particularly of compounds such as 5-thio-D-glucose or mannitol, may also be readily tolerated. In one embodiment, the compound provided to a mammal on a daily basis may be from about 0.1, 0.5, 1, 2, or 5 mg/kg to about 15, 20, 50, 100, 150, or 200 mg/kg, and all combinations of these ranges. In one embodiment, the amount fed to the mammal, on a daily basis, may be from about 1 mg/kg to about 15 mg/kg, from about 2 mg/kg to about 10 mg/kg, or from about 2 mg/kg to about 5 mg/kg. In one embodiment, the amount fed to the mammal, on a daily basis, may be from about 1 mg/kg to about 5 mg/kg, from about 1.5 mg/kg to about 5 mg/kg, from about 2 mg/kg to about 5 mg/kg, or about 2 mg/kg. In certain embodiments, these amounts may translate to compositions comprising mannoheptulose and/or perseitol less than about 5%, or less than about 2%, or from about 0.0001% to about 0.5%, or from about 0.1% to about 10%, or from about 0.1% to about 5%, of the component, all by weight of the composition. All ranges there between are envisioned. The level of component may be determined by one of ordinary skill in the art based on a variety of factors, for example, the form of the composition (e.g., whether a dry composition, semi-moist composition, wet composition, or supplement, or any other form or mixture thereof). The ordinarily skilled artisan will be able to utilize the preferred amount to be fed and determine the optimal level of component within a given feed composition.

Similarly, the overall amount of the component on a daily basis provided to the mammal can be from about 0.1 mg per day to about 1000 mg per day. Such daily amounts can be dependent on the size of the mammal consuming the composition. For example, in one embodiment, larger mammals may consume more than smaller mammals. Of course, that is consistent with the amounts disclosed herein with respect to the mass of the mammal. Thus, in one embodiment, as the mammal increases in size, more of the composition can be fed.

Accordingly, in one embodiment, such a daily amount can correspond to the amount on a daily basis per mass of the mammal, as described herein. Specifically, daily amounts can range, in some embodiments, from about 0.1 mg per day to about 1000 mg per day, or even more, depending on the size of the mammal and the daily amounts as described above. In other embodiments, the daily amount can be from about 1 mg per day to about 500 mg per day, or from about 1 mg per day to about 200 mg per day, or from about 1 mg per day to about 100 mg per day, or from about 5 mg day per day to about 100 mg per day, or from about 5 mg per day to about 80 mg per day, or from about 10 mg per day to about 50 mg per day, or about 40 mg per day. All ranges there between are also envisioned.

As noted, embodiments of the invention are directed to a composition that is intended for ingestion by a mammal. Compositions include foods intended to supply necessary dietary requirements, as well as treats (e.g., biscuits) or other food supplements. Optionally, the composition herein may be a dry composition (for example, kibble), semi-moist composition, wet composition, or any mixture thereof. Alternatively or additionally, the composition is a supplement, such as a gravy, drinking water, yogurt, powder, suspension, chew, treat (e.g., biscuits) or any other delivery form.

The compositions herein can be complete and nutritionally balanced. A complete and nutritionally balanced composition may be compounded to be fed as the sole ration and is capable of maintaining life without any additional substance being consumed, except for water. Alternatively, the composition can be a nutritional supplement that is administered in addition to routine feeding.

The compositions used herein may optionally comprise one or more further components. Other components are beneficial for inclusion in the compositions used herein, but are optional for purposes of the invention. In one embodiment, the compositions may comprise, on a dry matter basis, from about 10% to about 90% crude protein, alternatively from about 20% to about 50% crude protein, alternatively from about 20% to about 40% crude protein, by weight of the composition, or alternatively from about 20% to about 35% crude protein, by weight of the composition. The crude protein material may comprise vegetable-based proteins such as soybean, cereals (corn, wheat, etc), cottonseed, and peanut, or, more preferably, animal-based proteins such as casein, albumin, and meat protein. Non-limiting examples of meat protein useful herein include a protein source selected from the group consisting of beef, pork, lamb, poultry, fish, and mixtures thereof.

Furthermore, embodiments of the compositions may comprise, on a dry matter basis, from about 5% to about 40% fat, alternatively from about 10% to about 35% fat, by weight of the composition.

Embodiments of the compositions of the invention may comprise a source of carbohydrate. In one embodiment, the compositions may comprise from about 35%, by weight of the composition, up to about 50%, by weight of the composition, carbohydrate source. In other embodiments, the composition can comprise from about 35% to about 45%, by weight of the composition, or from about 40% to 50%, by weight of the composition, carbohydrate source. Grains or cereals such as rice, corn, milo, sorghum, barley, wheat, and the like are illustrative sources of carbohydrate. Corn levels can range to 80%, or more.

The compositions may also contain other materials such as, but not limited to, dried whey and other dairy by-products, beet pulp, cellulose, fiber, fish oil, flax, vitamins, minerals, flavors, antioxidants, and taurine.

The compositions may also contain other optional ingredients. Optional ingredients can include Probiotic components (Bifidobacteria and/or Lactobacillus) and Prebiotic (fructooligosaccharides) components. Examples and amounts of Probiotic components and Prebiotic components that can be included are disclosed in United States Publication No. 2005/0158294, for example. Other optional ingredients that can be included are omega 6 and omega 3 fatty acids, carnitine, hexametaphosphate, glucosamine, chondroitin sulfate, carotenoids including beta carotene, vitamin E, and lutein and mixtures thereof.

### Kibble Compositions

Table 1 illustrates two kibble compositions having the following components at the approximate indicated amounts are prepared using methods which are standard in the art, including extrusion, and are fed to dogs and/or cats as a daily feed:

TABLE 1

| | Component Amount | Component Amount |
|---|---|---|
| Component | indicated as Wt % | indicated as Wt % |
| Criollo Avocado Flesh* | q.s. 0.02% MH* | q.s. 0.01% MH* |
| Chicken, Chicken By- | 44 | 47 |
| product Meal, Fish Meal, | | |
| and Egg | | |
| Chicken Fat | 8 | 6 |
| Beet Pulp | 2 | 3 |
| Salts | 2.5 | 2 |
| Vitamins and Minerals** | 1 | 1 |
| Minors*** | 3.5 | 4 |
| Grains | Balance to 100% | Balance to 100% |
| (corn, sorghum, barley, rice, | | |
| wheat) | | |

*Criollo Avocado fruit (including pit and peel) ripened as disclosed hereinabove then ground and macerated; quantity sufficient (“q.s.”) to provide the indicated percentage of mannoheptulose (“MH”) in the composition.
**Vitamins and Minerals may include: Vitamin E, beta-carotene, Vitamin A, Ascorbic Acid, Calcium Pantothenate, Biotin, Vitamin B₁₂, Vitamin B₁, Niacin, Vitamin B₂, Vitamin B₆, Vitamin D₃, Vitamin D₂, Folic Acid, Chlorine Chloride, Inositol, Calcium Carbonate, Dicalcium Phosphate, Potassium Chloride, Sodium Chloride, Zinc Oxide, Manganese Sulfate, Copper Sulfate, Manganous Oxide, Ferrous Sulfate, Potassium Iodide, Cobalt Carbonate.
***Minors may include: Fish oil, flax seed, flax meal, cellulose, flavors, antioxidants, taurine, yeast, carnitine, chondroitin sulfate, glucosamine, lutein, rosemary extract.

The following examples further describe and demonstrate embodiments within the scope of the invention. The examples are given solely for the purpose of illustration and are not to be construed as limitations of the present invention, as many variations thereof are possible without departing from the spirit and scope of the invention. All of the following examples are compositions that are utilized by a human or lower animal.

Dry compositions
Parts by Weight

| | Exam- | Exam- | Exam- | Exam- | Exam- | Exam- |
|---|---|---|---|---|---|---|
| Ingredient | ple A | ple B | ple C | ple D | ple E | ple F |
| Protein | 25.9000 | 48.0000 | 45.0000 | 54.9000 | 56.0000 | 50.0000 |
| products | | | | | | |
| and meals | | | | | | |
| Cereal grains | 63.6000 | 36.1000 | 37.0000 | 27.4000 | 26.8000 | 32.0000 |
| Fat | 2.6000 | 5.8000 | 7.0000 | 6.0000 | 6.0000 | 7.0000 |
| Egg product | 3.5000 | 2.0000 | 3.0000 | 2.0000 | 2.0000 | 2.0000 |
| Vitamins | 0.2000 | 0.4000 | 0.6000 | 0.8000 | 0.4000 | 0.4000 |
| Minerals | 0.2000 | 0.8000 | 0.4000 | 0.8000 | 0.8000 | 0.6000 |
| Fiber | 3.0000 | 5.9000 | 6.0000 | 7.1000 | 7.0000 | 7.0000 |
| Criollo | 0.0001 | 0.050 | 0.075 | 0.500 | 0.900 | 1.0000 |
| Avocado | | | | | | |

*Whole avocado fruit secured from the process disclosed herein, ground, macerated and used in a quantity sufficient (q.s.) to provide a 1:1 (wt) mixture of mannoheptulose and perseitol at the concentration specified in each of Examples A through F. The avocado is derived from West Indian and West Indian/Guatemalan hybrid criollo avocados. In one embodiment, the fruit is peeled. In another embodiment, the pit is at least partially removed from the fruit.

The dry compositions of Examples A-F can be made by first milling and mixing the cereal grains with protein meal, egg products, vitamins and minerals and fiber sources and avocado flesh or mannoheptulose or glucose anti-metabolite. Then, add the mixed, dried ingredients to the meat products and fat sources. Extrude the ingredients into kibbles. Dry the kibbles. Package the finished product.

### Other Optional Ingredients and Ranges:

In addition to proteinaceous, farinaceous, vitamin and mineral materials, the compositions of the invention generally may include other optional additives such as flavorings, preservatives, emulsifiers and humectants. The nutritional balance, including the relative proportions of vitamins, minerals, protein, fat and carbohydrate, is determined according to dietary standards known in the veterinary and nutritional art. The following ranges are simply for illustration purposes and are not intended to be limiting.

Nonlimiting examples of dry compositions may optionally contain on a dry matter basis, from about 1% to about 50% crude protein, from about 0.5% to about 25% crude fat, from about 1% to about 10% supplemental fiber, all by weight of the composition. The dry composition may have a total moisture content from about 1% to about 30% moisture. Alternatively, a dry composition may contain on a dry matter basis, from about 5% to about 35% crude protein, from about 5% to about 25% crude fat, from about 2% to about 8% supplemental fiber, all by weight of the composition. The dry composition may have a total moisture content from about 2% to about 20% moisture. Alternatively, the dry composition contains on a dry matter basis, a minimum protein level of about from about 9.5% to about 35%, a minimum fat level of from about 8% to about 20%, a minimum supplemental fiber level of from about 3% to about 7%, all by weight of the composition. The dry animal composition may also have a minimum metabolizable energy level of about 3.5 Kcal/g. The dry composition may have a total moisture content from about 3% to about 10%.

Nonlimiting examples of a semi-moist composition may optionally contain on a dry matter basis, from about 0.5% to about 50% crude protein, from about 0.5% to about 25% crude fat, from about 0.5% to about 15% supplemental fiber, all by weight of the composition. The semi-moist composition may have a total moisture content from about 30% to about 50% moisture. Alternatively, the semi-moist compositions may contain on a dry matter basis, from about 5% to about 35% crude protein, from about 5% to about 25% crude fat, from about 1% to about 5% supplemental fiber, and all by weight of the composition. The semi-moist composition may have a total moisture content from about 35% to about 45% moisture. Alternatively, the semi-moist composition may have on a dry matter basis, a minimum protein level of about from about 9.5% to about 22%, a minimum fat level of from about 8% to about 13%, a minimum supplemental fiber level of from about 2% to about 3%, all by weight of the composition. The semi-moist composition may have a total moisture content from about 38% to about 42%. The semi-moist composition may also have a minimum metabolizable energy level of about 3.5 Kcal/g and from about 0.1% to about 20% ash, and from about 0.001% to about 5.0% taurine.

Nonlimiting examples of a moist composition may optionally contain on a dry matter basis, from about 0.5% to about 50% crude protein, from about 0.5% to about 25% crude fat, from about 0.01% to about 15% supplemental fiber, all by weight of the composition. The moist composition may have a total moisture content from about 50% to about 90% moisture. Alternatively, the moist compositions may contain on a dry matter basis, from about 5% to about 35% crude protein, from about 5% to about 25% crude fat, from about 0.05% to about 5% supplemental fiber, all by weight of the composition. The moist composition may have a total moisture content from about 60% to about 85% moisture. Alternatively, a moist animal composition may contain on a dry matter basis, a minimum protein level of about from about 9.5% to about 22%, a minimum fat level of from about 8% to about 13%, a minimum supplemental fiber level of from about 0.1% to about 3%, all by weight of the composition. The moist composition may have a total moisture content from about 65% to about 80%. The moist composition may also have a minimum metabolizable energy level of about 1.0 Kcal/g and from about 0.1% to about 20% ash, and from about 0.001% to about 5.0% taurine.

In one embodiment of the present invention, the composition, whether dry, moist, semi-moist or otherwise, comprises on a dry matter basis, from about 5% to about 50%, alternatively 20% to about 50% of animal-derived ingredients, by weight of the composition. Non-limiting examples of animal-derived ingredients include chicken, beef, pork, lamb, turkey (or other animal) protein or fat, egg, fishmeal, and the like.

Where the composition is in the form of a gravy, the composition may comprise at least 10% of a broth, or stock, non-limiting examples of which include vegetable beef, chicken or ham stock. Typical gravy compositions may comprise on a dry matter basis, from about 0.5% to about 5% crude protein, and from about 2% to about 5% crude fat.

Where the composition is in the form of a supplement or “treat,” such as biscuits, chews, and other treats, the supplement may comprise, on a dry matter basis, from about 20% to about 60% protein, from about 22% to about 40% protein, by weight of the supplement composition. As another non-limiting example, the compositions may comprise a supplement comprising a dry matter basis, from about 5% to about 35% fat, or from about 10% to about 30% fat, by weight of the supplement composition, along with optimal vitamins and minerals. Compositions, treats and supplement compositions intended for use by animals such as cats or dogs are commonly known in the art.

The compositions of the present invention can further comprise a wide range of other optional ingredients. It is to be understood that they can include vegetables, non-avocado fruit, egg-based materials, undenatured proteins, food grade polymeric adhesives, gels, polyols, starches, gums, seasonings, salts, colorants, time-release compounds, minerals, vitamins, antioxidants, aroma modifiers, textured wheat protein, textured soy protein, textured lupin protein, textured vegetable protein, breading, flour, comminuted pasta, and combinations thereof.

Other examples of optional ingredients can include at least one vegetable. Nonlimiting examples of vegetables include carrots, peas, potatoes, cabbage, celery, beans, corn, tomatoes, broccoli, cauliflower, leeks and combinations thereof.

Also useful herein, as an optional ingredient, is a filler. The filler can be a solid, a liquid or packed air. The filler can be reversible (for example thermo-reversible including gelatin) and/or irreversible (for example thermo-irreversible including egg white). Nonlimiting examples of the filler include gravy, gel, jelly, aspic, sauce, water, air (for example including nitrogen, carbon dioxide, and atmospheric air), broth, and combinations thereof.

Nonlimiting examples of colorants include, but are not limited to, synthetic or natural colorants, and any combination thereof. When present the colorants are from about 0.0001% to about 5%, from about 0.001% to about 1%, from about 0.005% to about 0.1%, on a dry matter basis, of said colorant.

Also useful herein, as an optional ingredient, is at least one non-avocado fruit. Nonlimiting examples include tomatoes, apples, pears, peaches, cherries, apricots, plums, grapes, oranges, grapefruit, lemons, limes, cranberries, raspberries, blueberries, watermelon, cantaloupe, muskmelon, honeydew melon, strawberries, banana, and combinations thereof.

The compositions may optionally contain other materials such as dried whey and other dairy by-products.

The compositions may optionally contain other active agents such as long chain fatty acids and zinc. Suitable long chain fatty acids include alpha-linoleic acid, gamma linolenic acid, linoleic acid, eicosapentanoic acid, and docosahexanoic acid. Fish oils are a suitable source of eicosapentanoic acids (EPA) and docosahexanoic acid (DHA). A useful DHA level is at least about 0.05%, alternatively at least about 0.1%, alternatively at least about 0.15% of the animal food composition, all on a dry matter basis. A useful EPA level is at least about 0.05%, alternatively at least about 0.1%, alternatively at least about 0.15% of the animal food composition, all on a dry matter basis.

### Analyses

### I. Sugar Profile in Avocado Raw Material and Dry Pet Food by Ion Chromatography (IC).

### Principle:

This method is for the analysis of perseitol, mannoheptulose, glucose, sucrose, and fructose in avocado raw material and dry pet food. The method involves extraction of sugars with 18.2 mΩ water followed by separation of sugars on an IC column with electrochemical detection.

### Apparatus:

| | SUGGESTED TYPE OR SOURCE |
|---|---|
| | (Equivalent Items May be Used Except |
| APPARATUS | Where Noted) |
| IC | Dionex ICS 5000 with an |
| | electrochemical detector |
| IC Column | Dionex Carbopac PA-20 analytical |
| | column, 3 × 30 mm (P/N 060142) |
| Guard Column | Dionex Amino Trap, 2 × 50 mm (P/N |
| | SP5578) |
| Borate Trap | Dionex Borate Trap, 4 × 50 mm (P/N |
| | 047078) |
| ATC | Dionex IonPac ATC-3, 4 × 35 mm (P/N |
| | 059661) |
| Gradient Mixer | Dionex GM4 (P/N 049135) |
| Clear Autosampler Vials | Sun Sri 200 250 |
| Black Autosampler Caps | Sun Sri 500 061 |
| Auto Pipette | Rainin |
| 0.2 um Nylon Centrifuge Filter | VWR 82031-358 |
| 15 ml Centrifuge Tubes | FALCON 352097 |
| Balance | Mettler Toledo, 4 place (for samples) |
| | Mettler MT5 (for stock standard) |
| Clear Volumetric Flasks | (Class A) VWR |
| Disposable Transfer Pipettes | 5 mL Polyethylene, VWR 16001-194 |
| Centrifuge | IEC Centra GP8R |
| Vortex | Scientific Industries, Vortex Genie 2 |
| Micro Centrifuge | Thermo Scientific Pico 21 |
| Metal Spatula | VWR |

Reagents and Solutions: (Equivalent Items May be Used)

### 50% W/W Sodium Hydroxide—J.T. Baker 3727-01

### Standards:

| | |
|---|---|
| Perseitol | Sigma-Aldrich P8295-1G |
| Mannoheptulose | Synthesized PG895398 |
| Glucose | Sigma-Aldrich G8270-10G |
| Sucrose | Sigma-Aldrich S9378-500G |
| Fructose | Sigma-Aldrich F0127-100G |

### Procedure:

### Stock Standard Preparation

1. Weigh 10 mg of each of the five sugars using a Mettler MT5 balance and transfer to a 1 L volumetric flask.
2. Fill up to the mark with 18.2 mΩ purified water.
3. Stir using a stir bar and a plate for 10 minutes.

Stock standard solution is stable for 2 months when stored in the refrigerator. Approximate concentration of each sugar in the stock solution is 10 ug/mL. Allow the stock standard to reach room temperature before making dilutions.

### Linearity Standard Preparation

Prepare linearity standards by dilution of the specified volume of stock into the clear autosampler vials indicated. Dilute to volume with 18.2 mΩ purified water.

| Standard | | | Approx. Conc. of | |
|---|---|---|---|---|
| Level | Aliquot of Stock | Volume of Diluent | Each Standard | |
| 1 | 100 uL | 900 ul | 1 | ug/mL |
| 2 | 250 uL | 750 ul | 2.5 | ug/mL |
| 3 | 500 uL | 500 ul | 5 | ug/mL |
| 4 | 750 uL | 250 ul | 7.5 | ug/mL |
| 5 | 1000 uL | 0 ul | 10.0 | ug/mL |

Linearity standards in autosampler vials are stable for a week after they are prepared. They are to be stored in the instrument autosampler at 4° C. They are to be discarded at the end of the week.

### Sample Preparation: Extraction

Prepared samples are stable for 1 week in autosampler vials stored in the instrument at 4° C. Control sample is extracted using the same procedure as unknown samples.
1. Tare a 15 mL centrifuge tube.
2. Accurately weigh 1.000 to 1.100 grams of sample into the tube using Mettler Toledo 4 place balance.
3. Add 10 ml of 18.2 mΩ (1:10 dilution)
4. Place the tube in a vortex on the highest setting for 10 minutes.
5. Place the tube in IEC Centra GP8R at 2450 RPM for 5 minutes.
6. Transfer approximately 1 ml from the water layer (clear mid layer) into a 0.2 um nylon centrifuge filter using a transfer pipette.
7. Place filter in a microcentrifuge set to 14,800 RCF (12,400 RPM for the Thermo Scientific Pico 21).

### Sample Preparation: Dilutions

Extraction step contains a 1:10 dilution for all samples. Different samples will require different dilution strategies. Below are a set of standard dilution strategies.

| | | Final |
|---|---|---|
| Initial | | Dilution |
| Dilution | Procedure | Factor |
| 10 | Transfer 100 ul of the extract to a clear autosampler | 100 |
| | vial. Add 900 ul of 18.2 mΩ. | |
| 100 | Transfer 100 ul of the extract to a 10 ml clear | 1,000 |
| | volumetric flask. Fill up to the mark with 18.2 mΩ. | |
| | Cap, invert to mix. | |
| 500 | Transfer 100 ul of the extract to a 50 ml clear | 5,000 |
| | volumetric flask. Fill up to the mark with 18.2 mΩ. | |
| | Cap, invert to mix. | |
| 1,000 | Transfer 100 ul of the extract to a 100 ml clear | 10,000 |
| | volumetric flask. Fill up to the mark with 18.2 mΩ. | |
| | Cap, invert to mix. | |
| 10,000 | Transfer 100 ul of the extract to a 100 ml clear | 100,000 |
| | volumetric flask. Fill up to the mark with 18.2 mΩ. | |
| | Cap, invert to mix. Transfer 100 ul of this solution | |
| | to a clear autosampler vial. Add 900 ul of 18.2 mΩ. | |

### Eluent Preparation:

Eluent A (18.2 mΩ Water): Triple rinse eluent reservoir with 18.2 mΩ water and fill it up to 1.8 L mark with 18.2 mΩ water. Degas for 20 minutes with nitrogen while stirring on a stirring plate. Immediately after degassing, place the reservoir on top of the instrument and cap under nitrogen. Eluent A is stable for 2 weeks.

Eluent B (0.2M NaOH): Degas, 2 L or 18.2 mΩ water in a 2 L eluent bottle for 20 minutes. Using a transfer pipette, transfer 21 ml of 50% NaOH from the center portion of the 50% NaOH container to a 2 L volumetric flask. (Do not shake the 50% NaOH container. Do not transfer NaOH from the bottom or the top portion of the container to avoid contamination from sodium bicarbonate precipitate. Do not pour NaOH from the container since carbonate flakes collect around the container rim.) Transfer the NaOH slowly into the 2 L volumetric flask and fill up to the mark with 18.2 mΩ water. Cap, invert to mix the solution. Slowly pour the solution to an eluent reservoir and degas for 20 minutes with nitrogen. Immediately after degassing, place the reservoir on top of the instrument and cap. Eluent B is stable for 3 months.

Eluent C (1M NaOH): Degas 2 L of 18.2 mΩ water in a 2 L eluent bottle for 20 minutes. Using a transfer pipette, transfer 104.6 ml of 50% NaOH from the center portion of the 50% NaOH container to a 2 L volumetric flask. (Do not shake the 50% NaOH container. Do not transfer NaOH from the bottom or the top portion of the container to avoid contamination from sodium bicarbonate precipitate. Do not pour NaOH from the container since carbonate flakes collect around the container rim.) Transfer the NaOH slowly into the 2 L volumetric flask and fill up to the mark with 18.2 mΩ water. Cap, invert to mix the solution. Slowly pour the solution to an eluent reservoir and degas for 20 minutes with nitrogen. Immediately after degassing, place the reservoir on top of the instrument and cap. Eluent C is stable for 3 months.

Eluent D (2M NaOH): Degas 2 L of 18.2 mΩ water in a 2 L eluent bottle for 20 minutes. Using a transfer pipette, transfer 209.2 ml of 50% NaOH from the center portion of the 50% NaOH container to a 2 L volumetric flask. (Do not shake the 50% NaOH container. Do not transfer NaOH from the bottom or the top portion of the container to avoid contamination from sodium bicarbonate precipitate. Do not pour NaOH from the container since carbonate flakes collect around the container rim.) Transfer the NaOH slowly into the 2 L volumetric flask and fill up to the mark with 18.2 mΩ water. Cap, invert to mix the solution. Slowly pour the solution to an eluent reservoir and degas for 20 minutes with nitrogen. Immediately after degassing, place the reservoir on top of the instrument and cap. Eluent D is stable for 3 months.

### IC Parameters:

Flow: 0.4 mL/min

### Column Temp: 30 C

### Autosampler Tray Temp: 4 C

### Injection Volume: 10 uL

### Eluents: A=Water, B=0.2M NaOH, C=1M NaOH, D=2M NaOH

### Gradient Elution:

| | | | | |
|---|---|---|---|---|
| 0 min | 96% A | 4% B | 0% C | 0% D |
| 24 min | 96% A | 4% B | 0% C | 0% D |
| 25 min | 0% A | 0% B | 0% C | 100% D |
| 40 min | 0% A | 0% B | 0% C | 100% D |
| 41 min | 96% A | 4% B | 0% C | 0% D |
| 52 min | 96% A | 4% B | 0% C | 0% D |

Run Time: 52 minutes

### Chromatographic Sequence:

Inject the 18.2 mΩ at least one time at the start of each run.

Inject linearity standards 1 through 5 once each before and after the samples.

Inject the control sample once each before and after the samples.

### System Suitability:

1. The % RSD for the average retention time for mannoheptulose for the first 5 standard injections is ≦5.0%.
2. Peak asymmetry for mannoheptulose for the first 5 standard injections is ≦2.0.
3. Linearity is determined using all standard injections. The correlation coefficient (r²) for each tocopherol is >98.0.
4. A control is included to monitor drift throughout the chromatographic sequence. The control can be any diet or raw material with at least 500 ppm mannoheptulose and no interfering peaks.
   Calculations: Performed in Chromeleon software.

$$( \frac{Area Count - y \text{-} intercept}{Slope} ) * ( \frac{Dilution Factor}{Sample Weight ( gm )} )$$

### Results:

Report results in ppm to four significant figures for each sugar. For example, 100.1 ppm.

### Chromatographic Elution Times:

Chromatographic separation of the various materials of interest herein yields quite distinct elution times, which allows them to be readily identified and quantified. Representative elution times are shown in Table 1.

TABLE 1

| | |
|---|---|
| Perseitol | 3.009 Minutes |
| Mannoheptulose | 10.784 Minutes |
| Glucose | 14.817 Minutes |
| Sucrose | 16.409 Minutes |
| Fructose | 20.359 Minutes |

### II. Fat Determination by Acid Hydrolysis

The procedure for the termination of percent fat by gravimetric analysis is as follows.

### Apparatus Type or Source

### (Equivalent Items May be Used)

| | |
|---|---|
| Analytical Balance | Accurate to +/−0.0001 g |
| Fume Hood | Explosion proof |
| Shaking Water Bath - 70-80° C. | |
| Mojonnier Flasks | |
| Pipettes or Repipettes, 2 mL, 10 mL, | |
| 15 mL, 25 mL | |
| Air Oven - 135° C. | |
| Desiccator | |
| Mechanical Shaker | Glass Col Bench Top Shakes |
| Steam Table | |
| Stoppers - sized to fit Mojonnier flasks | |
| (#1) | |
| Long Stem Glass Funnels | |
| Cotton Balls - triple size | |
| Funnel Rack | |
| Tongs | |
| Desiccant | |
| Timer | T.H.E. desiccant or similar |
| | desiccant |
| Glass Beakers, 150 mL | |
| Centrifuge | |

### Reagents and Solutions Purity Type or Source

### (Equivalent Items May be Used)

| | |
|---|---|
| Ethyl Alcohol (95%) | [CAS 64-17-5] |
| Anhydrous Ethyl Ether | [CAS 60-29-7] |
| Petroleum Ether | [CAS 8030-30-6] |
| Hydrochloric Acid (25/11 dilution) | [CAS 7647-01-0] |

### Procedure

### Reagent Preparation

Hydrochloric Acid (25/11 dilution)
1000 mL concentrated HC 1 added to 440 mL deionized water.

### Sample Preparation

1. Grind sample to a uniform texture.
2. Weigh a 2 g sample (feed or fruit) or a 1 g sample (fecal) and place into a Mojonnier flask.
3. Record sample weight.
4. Wet sample with 2 ml Ethyl Alcohol, be sure to saturate the sample (may need slightly more Ethyl Alcohol for fecal samples).

### 5. Add 10 ml HC1.

6. Place Mojonniers in preheated shaking water bath (75.0°) for 45 minutes.
7. Remove from water bath and cool to room temperature.
8. Weigh a clean, dry, 150 ml glass beaker.
9. Record weight.
10. Place a cotton plug in the long stem funnel and set beaker under the funnel.

### 11. Add 10 ml Ethyl Alcohol to Mojonnier and mix.

12. Add 25 ml Ethyl Ether (Anhydrous Ether) to Mojonnier, stopper, shake for one minute (use mechanical shaker).
13. Add 25 ml Petroleum Ether to Mojonnier, stopper, shake for 1 minute.
14. Put Mojonnier in centrifuge for about one minute to let the ether and residue separate.
15. Pour off top ether layer through cotton plug in funnel.
16. Repeat steps 13 through 15 twice more except reduce the ethers to 15 ml each (this makes a total of three pour-offs).
17. Rinse the sides of the funnel and the cotton plug with a 50/50 blend of the two ethers.
18. Use the stopper to push either out of the cotton plug.
19. Evaporate off the ether (a steam table works best).
20. Place the beakers in a 135° C. air oven for 10 minutes.
21. Weigh back, record weight, and calculate.

### Acid Hydrolysis Fat on Liquid Digest

1. Weigh a 5 g sample.
2. Make sure the entire sample is in the bulb of the Mojonnier.
3. To assure that the sample is completely in the bulb, use a disposable syringe and a flexible straw. The straw is the right length to reach the bulb and, being flexible, will adjust to the curve of the Mojonnier.

### Calculations

$$\% Fat = \frac{( wt of beaker \& fat - wt of empty beaker ) * 100}{sample wt}$$

### Results

Report results as % Fat to 1 decimal place.

### Notes

### Possible Sources of Error

Funnels should be washed between uses to eliminate any carryover.
The mixture of ether should be 1:1. Too much ethyl ether will cause high results, and too much petroleum ether will cause low results.
Make sure beakers have cooled to room temperature before weigh back. Heat will cause fluctuations in weights.

It should be understood that every maximum numerical limitation given throughout this specification includes every lower numerical limitation, as if such lower numerical limitations were expressly written herein. Every numerical range given throughout this specification includes every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be clear to those skilled in the art that various other changes and modifications can be made without departing from the spirit and scope of the invention. It is therefore intended to cover in the appended claims all such changes and modifications that are within the scope of this invention.

1. A method for supplying a member selected from the group consisting of mannoheptulose, perseitol and mixtures thereof to an edible food composition component, said food composition component comprising a non-avocado derived member selected from the group consisting of protein, fat, carbohydrate and mixtures thereof, by combining a criollo avocado-derived component containing said mannoheptulose, perseitol or mixtures thereof with said food composition component.

2. A method according to claim 1, wherein said criollo is a member selected from the group consisting of criollo West Indian avocado, criollo West Indian/Guatemalan hybrid avocado and mixtures thereof.

3. A method according to claim 1, wherein said criollo avocado is grown in the Dominican Republic.

4. A method according to claim 3, wherein said criollo avocado is an early harvest criollo avocado.

5. A method according to claim 1, wherein said criollo avocado-derived component comprises the criollo avocado flesh plus a member selected from avocado pit, avocado peel, or both pit and peel.

6. A method according to claim 1, wherein said criollo avocado-derived component is an aqueous extract comprising said mannoheptulose and optionally perseitol.

7. A method according to claim 1, wherein said food composition component is animal protein.

8. A method according to claim 1, wherein said food composition component is a plant carbohydrate derived from a farinaceous source.

9. A method according to claim 1, wherein said food composition component is a non-avocado fat comprising omega-3 fatty acid moieties.

10. An animal food composition according to claim 1 comprising a nutritionally balanced mixture of said protein, carbohydrate, fat, optional vitamins and minerals, and an amount of criollo avocado-derived component to provide an effective amount of mannoheptulose sufficient to mimic the effects of caloric restriction in said animal.
